(19) United States
(12) Patent Application Publication
(10) Pub. No.: US 2025/0235880 A1
(43) Pub. Date: Jul. 24, 2025

(54) NOZZLE

(71) Applicant: Loxcreen Canada Ltd., Mississauga (CA)

(72) Inventors: Chris BROWN, Mississauga (CA); Andy MOKRYTSKIY, Mississauga (CA)

(21) Appl. No.: 19/035,499

(22) Filed: Jan. 23, 2025

Related U.S. Application Data
(60) Provisional application No. 63/624,044, filed on Jan. 23, 2024.

(51) Int. Cl. B05B 1/04; B05B 15/65

(52) U.S. Cl. CPC B05B 1/044; B05B 15/65

(57) ABSTRACT

The apparatus is for use with a tube of sealant, the tube having a longitudinal axis and an externally threaded end coaxial with the longitudinal axis. The apparatus comprises: a receiver having an internally threaded end adapted to threadingly, sealingly receive the end of the tube; a spreader that has a surface in which an elongate slot is defined, the slot being positioned such that the longitudinal axis is perpendicular to the slot and extends centrally therethrough, the surface being disposed in angular relation to the longitudinal axis; a pair of ribs projecting from the surface in flanking relation to the ends of the slot; and a nozzle extending from the receiver to the spreader.

### CROSS-REFERENCE TO RELATED APPLICATIONS

This application claims priority to U.S. Provisional Patent Application No. 63/624,044, filed Jan. 23, 2024.

### FIELD

The invention relates to the field of sealant.

### BACKGROUND

Sealing and bonding compounds such as that sold by MD under the trademark PROVA-SEAL are used to waterproof and seal pipe/valve protrusions in shower installations, cover fasteners and seal cracks, joints and seams in other applications needing water resistance, such as sinks and countertops. Products of this type are applied as a viscous liquid and can cure to create a watertight flexible seal that is not prone to shrinkage, cracking or crumbling. However, installation success requires a consistent thickness which can be difficult to judge: if too thick, curing can be delayed; if too thin, seal and adhesion can be prejudiced.

### SUMMARY

Forming one aspect of the invention is apparatus for use with a tube of sealant, the tube having a longitudinal axis and an externally threaded end coaxial with the longitudinal axis. The apparatus comprises: a receiver having an internally threaded end adapted to threadingly, sealingly receive the end of the tube; a spreader that has a surface in which an elongate slot is defined, the slot being positioned such that the longitudinal axis is perpendicular to the slot and extends centrally therethrough, the surface being disposed in angular relation to the longitudinal axis; a pair of ribs projecting from the surface in flanking relation to the ends of the slot; and a nozzle extending from the receiver to the spreader.

### BRIEF DESCRIPTION OF THE DRAWINGS

In the drawings:

FIG. 1 is a perspective view of apparatus according to an example embodiment of the invention;

FIG. 2 is a front end view of the apparatus of FIG. 1;

FIG. 3 is a side view of the apparatus of FIG. 1;

FIG. 4 is a bottom view of the apparatus of FIG. 1; and

FIG. 5 is a back end view of the apparatus of FIG. 1.

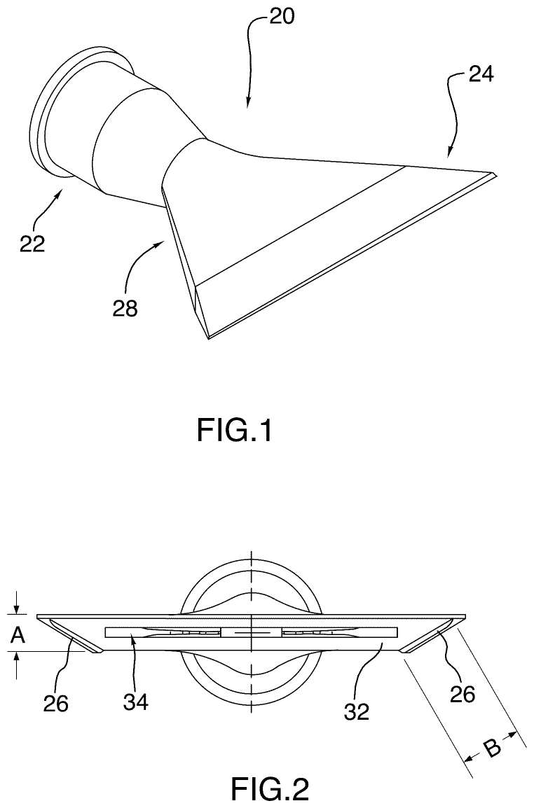

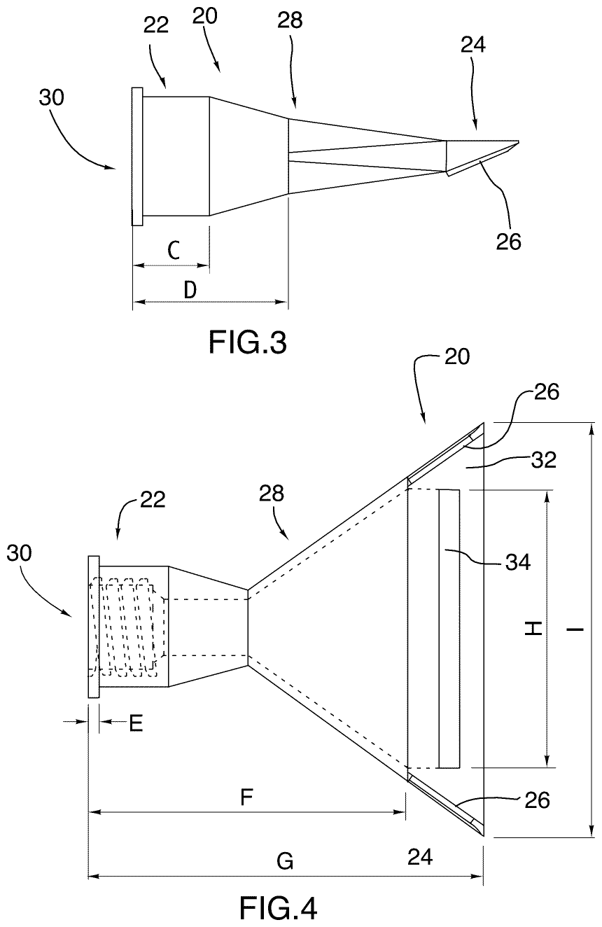

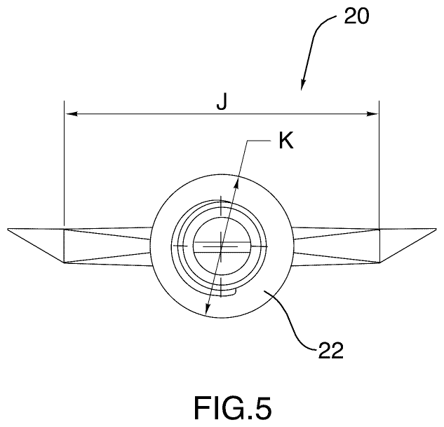

### DESCRIPTION

Apparatus 20 according to an example embodiment of the invention is shown in the drawings and will be understood to be for use a tube of sealant, the tube having a longitudinal axis and an externally threaded end coaxial with the longitudinal axis.

The apparatus comprises a receiver 22, a spreader 24, a pair of ribs 26 and a nozzle 28.

The receiver has an internally threaded end 30 adapted to threadingly, sealingly receive the end of the tube.

The spreader that has a surface 32 in the form of an isosceles trapezoid in which an elongate slot 34 is defined, the slot being positioned such that the longitudinal axis is perpendicular to the slot and extends centrally therethrough, the surface being disposed in angular relation to the longitudinal axis.

The ribs project from the surface in flanking relation to the ends of the slot.

The nozzle extends from the receiver to the spreader and flares at an angle such, when viewed in plan, in a direction perpendicular to both the longitudinal axis and the length of the slot, the ribs are aligned with the edges of the nozzle.

In the embodiment illustrated, the dimensions and angles indicated are as follows:
A=.21″
B=.025″
C=.5″
D=1.0″
E=.07″
F=2.00″
G=2.460″
H=1.740″
I=2.554″
J=1.900″
K=0.875″

In use, the apparatus dispenses and spreads sealant at the same time; the ribs allow the installer to apply an even coat.

Whereas a specific design is illustrated, it will be apparent that variations are possible.

Accordingly, the invention should be understood to be limited only by the accompanying claims, purposively construed.

1. Apparatus for use with a tube of sealant, the tube having a longitudinal axis and an externally threaded end coaxial with the longitudinal axis, the apparatus comprising:
a receiver having an internally threaded end adapted to threadingly, sealingly receive the end of the tube;
a spreader that has a surface in which an elongate slot is defined, the slot being positioned such that the longitudinal axis is perpendicular to the slot and extends centrally therethrough, the surface being disposed in angular relation to the longitudinal axis;
a pair of ribs projecting from the surface in flanking relation to the ends of the slot; and
a nozzle extending from the receiver to the spreader.
